(19) United States
(12) Patent Application Publication
(10) Pub. No.: US 2026/0087533 A1
(43) Pub. Date: Mar. 26, 2026

(54) SYSTEMS AND METHODS FOR DIGITAL TEMPLATE MANAGEMENT

(71) Applicant: ServiceTitan, Inc., Glendale, CA (US)

(72) Inventors: Sona Hambaryan, Glendale, CA (US); Lilit Ghukasyan, Glendale, CA (US); Wing Lam, San Gabriel, CA (US); Tianyu Qiu, Glendale, CA (US); Juliette Armour-Wilson, Santa Barbara, CA (US); Eyal Binshtock, Los Angeles, CA (US)

(21) Appl. No.: 19/342,016

(22) Filed: Sep. 26, 2025

Related U.S. Application Data
(60) Provisional application No. 63/699,592, filed on Sep. 26, 2024.

(51) Int. Cl. G06Q 30/0601

(52) U.S. Cl. CPC G06Q 30/0611

(57) ABSTRACT

Methods and systems for digital template management are disclosed. Historical data indicative of job estimates previously provided by a tenant to a plurality of customers is received. A subset of the job estimates is determined based on a frequency at which each of the job estimates occurs in the historical data. A machine learning model is trained, based on the subset of the job estimates, to generate a plurality of templates associated with jobs to be performed by the tenant. Each template from the plurality of templates corresponds to a type of job and indicates at least two job estimates from the subset of the job estimates. Storage of the plurality of templates in at least one database associated with the tenant is caused.

### PRIORITY

The disclosure claims the benefit under 35 U.S.C. § 119(e) of U.S. Provisional Patent Application No. 63/699,592 entitled “Systems and Methods for Digital Template Management,” filed on Sep. 26, 2024, which is incorporated herein by reference in its entirety.

### BACKGROUND

A tenant may hire service technicians (e.g., heating, ventilation, and air conditioning (HVAC) technicians, electricians, plumbers, etc.) to perform service jobs for customers. A service technician can generate an estimate before performing a service job for a customer. The customer can view the estimate to gain an understanding of the costs associated with performance of the service job before approving the service technician to begin performance of the service job. Oftentimes, there are multiple different combinations of services and/or materials that a service technician can use to perform a particular service job. It is important for the service technician to be able to generate various estimates that accurately reflect each of these different combinations of services and/or materials.

### SUMMARY

Methods, systems, and devices for digital template management are disclosed. The disclosed embodiments provide for a method, system, and non-transitory computer readable storage medium for improved digital template management. Historical data indicative of job estimates previously provided by a tenant to a plurality of customers is received. A subset of the job estimates is determined based on a frequency at which each of the job estimates occurs in the historical data. A machine learning model is trained to generate a plurality of templates associated with jobs to be performed by the tenant based on the subset of the job estimates. Each template from the plurality of templates corresponds to a type of job and indicates at least two job estimates from the subset of the job estimates. Storage of the plurality of templates in at least one database associated with the tenant is caused.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is an example system.

FIG. 2 is an example system.

FIG. 3 is an example template.

FIG. 4 is an example merging process.

FIG. 5 is an example method.

FIG. 6 is an example method.

FIG. 7 is an example method.

FIG. 8 is an example computing device.

### DETAILED DESCRIPTION OF ILLUSTRATIVE EMBODIMENTS

Methods and systems for template management are disclosed. A tenant can include a service provider, business, and/or company that performs service jobs (e.g., heating, ventilation, and air conditioning (HVAC) repair and maintenance, electrical or mechanical repair and maintenance, plumbing, etc.) for customers. A tenant may receive requests from its customers. The requests can include requests for the tenant to perform a service job for the customer, such as at a location (e.g., home, business, etc.) associated with the customer. In response to receiving a request from a customer, the tenant may dispatch one or more resources, such as service technicians, to the customer location to perform the service job.

A resource (e.g., service technician) that has been dispatched to a customer location can generate an estimate before performing a service job for a customer at the customer location. The customer can view the estimate to gain an understanding of the costs associated with performance of the service job before approving the service technician to begin performance of the service job. In many instances, there can be multiple different combinations of services and/or materials that the service technician can use to perform the service job. The customer may want to view an estimate for each of the different combinations of services and/or materials in order to select the combination of services and/or materials that aligns best with the needs and/or budget of the customer. However, it can be difficult for the service technician to identify different combinations of services and/or materials that are appropriate for performing a particular service job. Even if a service technician is able to identify different combinations of services and/or materials that are appropriate for performing a particular service job, it can still be difficult or time consuming for the service technician to generate separate estimates for each of the identified combinations. As such, improved techniques for automatic, templatized estimate generation are needed.

Described herein are techniques for automatic, templatized estimate generation. The techniques described herein enable automatic generation of templates for a tenant by a machine learning model. The machine learning model can generate the templates using an itemset mining algorithm (e.g., a Frequent Pattern Growth (FP-Growth) model) along with historical data and invoice data associated with the tenant. Each template can include a compilation of estimates that offer varying pricing options that each effectively address a particular homeowner (e.g., customer) issue. Each template can include, for example, three estimates (e.g., a “Good-Better-Best” trio). The first estimate (e.g., the “Good” estimate) can efficiently resolve the immediate issue associated with the system of the homeowner. The second estimate (e.g., the “Better” estimate) can, in addition to addressing the immediate issue, also include preventive maintenance to extend the system lifespan. The third estimate (e.g., the “Best” estimate) can address the immediate issue, while including preventive maintenance to extend the system lifespan and encompassing comprehensive upgrades that can enhance the entire system.

A service technician that has been dispatched to a customer location to perform a service job can easily retrieve a template associated with the type of service job (e.g., toilet installation, etc.) to provide a comprehensive estimate to the customer. The customer can view the various estimates comprised in the template to select a solution that best aligns with their needs and budget. For example, if the customer just wants the immediate issue addressed (e.g., the customer simply wants the toilet installed), the customer can choose the “Good” estimate. The “If the customer wants the service technician to address the immediate issue and perform preventive maintenance to extend the lifespan of the system, the customer can choose the “Better” estimate. Finally, if the customer wants the service technician to address the immediate issue, perform preventive maintenance to extend the lifespan of the system, and encompass one or more comprehensive upgrades to enhance the entire system, the customer can choose the “Best” estimate. When a homeowner selects an estimate as their preferred course of action, the cost of all associated services and/or materials can be automatically incorporated into the final invoice. In this manner, the techniques described herein prevent the need for tenants and/or service technicians to manually create templates, thereby saving time and enhancing efficiency in the service workflow, while also providing customers of the tenant with a tailored and effective service experience.

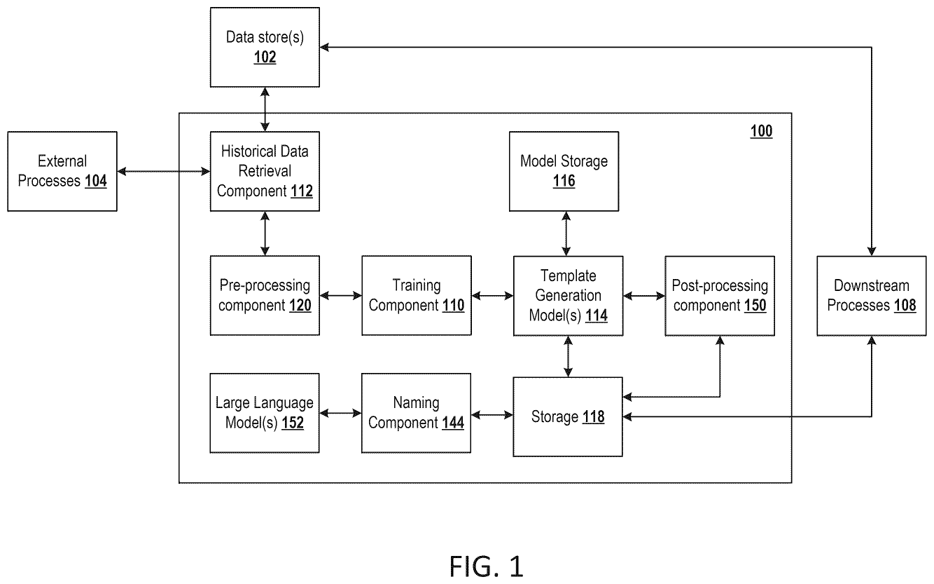

FIG. 1 shows a block diagram of an example system 100. The system 100 may include various functional blocks for performing the functions described herein. For example, the system 100 can interface with data stores 102, external processes 104, and downstream processes 108. For example, data stores 102 can include historical data associated with a tenant, including features specific to various service job requests received by the tenant. The features may include, for example, service job revenue, profits, estimates that the tenant has previously provided to customers (regardless of whether they were converted to a sale), service job totals and/or other features over a period of time, which may be used for training machine learning model(s). External processes 104 can include processes implemented outside the system 100 for obtaining historical data relevant to the job.

A historical data retrieval component 112 can include processes for retrieving the historical data from the data stores 102 and/or external processes 104. The historical data retrieval component 112 can be located remote to the data stores 102 and/or external processes 104. The data stored in the data stores 102 and/or the data obtained by the external processes 104 can include a large amount of data (e.g., an amount of data that is difficult or impossible to analyze or process manually). The data stored in the data stores 102 and/or the data obtained by the external processes 104 may be obtained from a variety of different sources, such that obtaining all of the data may be difficult or impossible to obtain manually. The historical data retrieved by the historical data retrieval component 112 can be provided to a pre-processing component 120.

The pre-processing component 120 can include processes for pre-processing the historical data retrieved by the historical data retrieval component 112. Pre-processing the historical data can include identifying high-frequency estimates in the historical data. The high-frequency estimates can include those estimates from the historical data that have been previously provided to customers (regardless of whether they were converted to a sale) at a frequency that satisfies (e.g., meets or exceeds) a threshold (e.g., five times, six times, etc.). In embodiments, the pre-processing component 120 can identify the high-frequency estimates based on determining that an amount of the historical data retrieved by the historical data retrieval component 112 satisfies a threshold. The threshold may be any amount of historical data, such as a total quantity of completed service jobs (e.g., 50 service jobs, 75 service jobs, 100 service jobs, 125 service jobs), or a total quantity of completed service jobs of a particular type.

The training component 110 can include processes for preparing the high-frequency estimates for use as training and test datasets (or subsets). The training datasets can be used for training one or more machine learning model(s) 114 and the testing datasets can be used for testing the machine learning model(s) 114 after they have been trained. For example, the training component 110 can receive high-frequency estimates associated with a particular company, or tenant from pre-processing component 120. The training component 110 can divide the received high-frequency estimates into a training dataset and a testing dataset (e.g., at an approximate respective ratio of 8:2).

The machine learning model(s) 114 may include one or more machine learning models. The training component 110 can train the machine learning model(s) 114 using the training dataset. The training component 110 can train the machine learning model(s) 114 to generate a plurality of templates associated with jobs to be performed by the tenant. Each template from the plurality of templates can corresponds to a type of job. Each template from the plurality of templates can indicate at least two job estimates from the subset of the job estimates.

In embodiments, the templates generated by the machine learning model(s) 114 can be stored in a storage 118 for later retrieval, such as for use by one or more service technicians associated with the tenant. For example, the templates stored in the storage 118 can be provided to downstream processes 108 to, for example and without imputing limitation, perform tasks associated with service jobs to be performed by the service technician(s). Names (e.g., titles) can be generated for each of the templates stored in the storage 118. The names can be generated by a naming component 144. The naming component 144 can utilize a large language model (LLM) 152 to generate the names for at least a portion of the templates stored in the storage 118. For example, the naming component 144 can input a prompt to the LLM 152 to cause the LLM 152 to generate the names for at least a portion of the templates stored in the storage 118. The names for the templates can be stored in the storage 118 along with the corresponding templates.

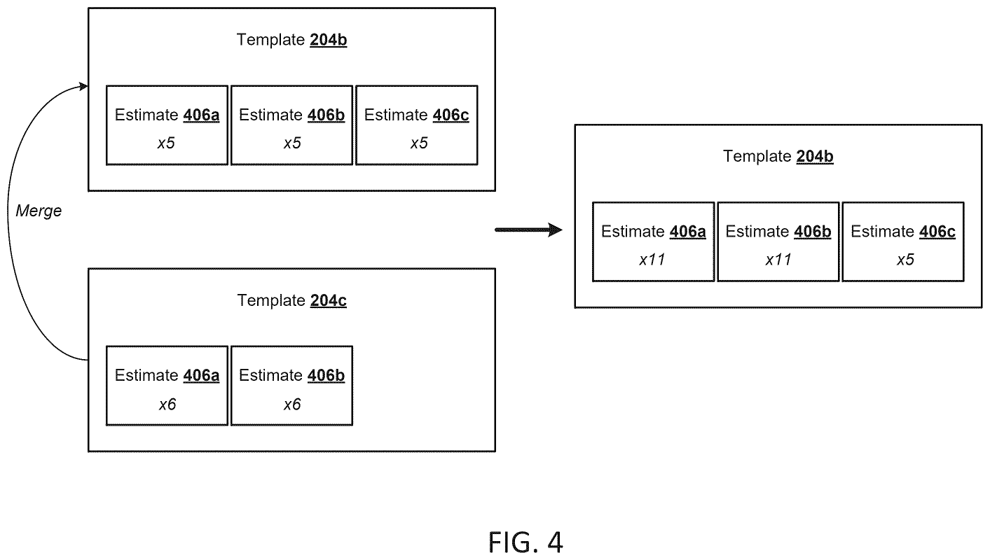

In embodiments, a post-processing component 150 can include processes for post-processing of one or more of the templates generated by the machine learning model(s) 114. For example, the post-processing of one or more of the templates can include merging templates that include a lower quantity of estimates (e.g., one or two estimates) with templates that include a higher quantity of estimates (e.g., three or more estimates). The merged templates can be stored in the storage 118 for later retrieval, such as for use by one or more service technicians associated with the tenant. The merging process is discussed in more detail below with regard to FIG. 4.

In embodiments, the machine learning model(s) 114 may be updated or retrained on a regularly scheduled and/or periodic basis (e.g., nightly, weekly, etc.) to ensure that the templates generated by the models accurately reflect shifts updates to or changes in the historical data associated with the tenant. The updated data can then be apportioned similarly as described above (e.g., 8:2 of training data to testing data) and provided to the model through a model training process. The updated or new templates generated by the machine learning model(s) 114 each time it is re-trained may be stored in the storage 118 for later retrieval, such as for use by one or more service technicians associated with the tenant. For example, the updated or new templates stored in the storage 118 can be provided to downstream processes 108 to, for example and without imputing limitation, perform tasks associated with service jobs to be performed by the service technician(s). As a result, each tenant model can keep up with, for example and without imputing limitation, changes in respective estimates. In effect, the accuracy of the templates is less susceptible to deterioration over time after initial model training. Further, the templates may adjust to periodic changes, such as seasonal changes and the like.

Once training of the model(s) 114 is complete, the model(s) 114 can be stored in a model storage 116 for later retrieval, such as for re-training of the model(s) 114. The model storage 116 can be a local data store, a remote data store, a distributed database or some combination of the above. The model storage 116 can store the model(s) 114 in association with a respective tenant (e.g., the tenant corresponding to the historical data retrieved). The retraining of the model(s) 114 can be performed according to a schedule and/or based on triggering events such as generation of a historical data.

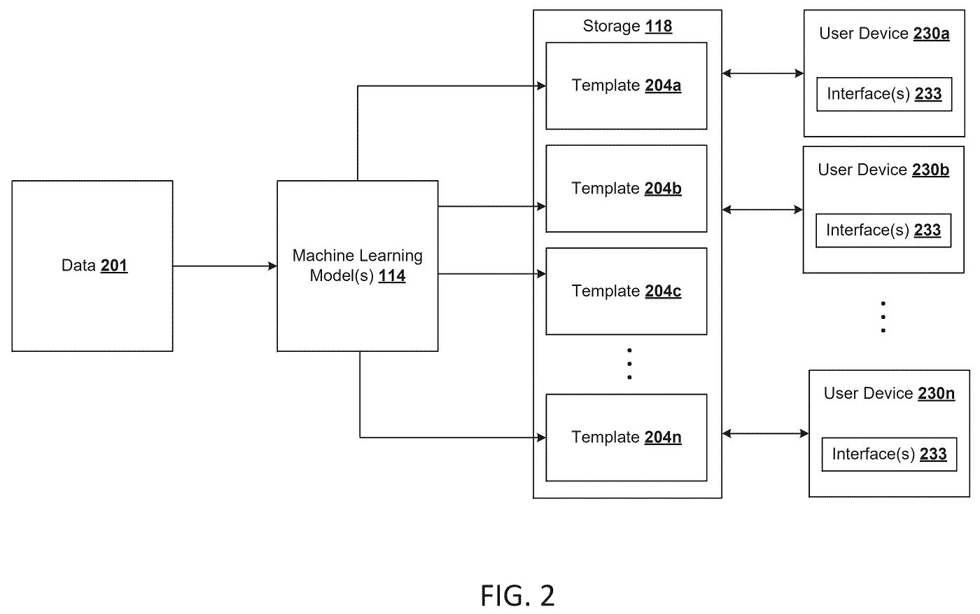

FIG. 2 is an example system 200. The system 200 may be utilized to implement improved techniques for digital template management. The system 200 may include the machine learning model(s) 114, the storage 118, and a plurality of user devices 230a-n The system 200 may enable tenants to gain a better understanding of the actual value that service jobs before dispatching service technicians to complete the service jobs.

The machine learning model(s) 114 may receive, as input, data 201. The data 201 may comprise job estimate data. The job estimate data can include data indicative of job estimates previously provided by a tenant to a plurality of customers. The job estimates can include job estimates that have been provided to the plurality of customers to enable the plurality of customers to gain an understanding of the costs associated with performance of the service job before approving the service technician to begin performance of the service job. The job estimates can include job estimates that have been converted to a sale (e.g., the customer viewed the estimate and approved the service technician to begin performance of the service job) and/or job estimates that have only been presented to a customer but not been converted to a sale. Each job estimate can indicate one or more line items (e.g., services (e.g., toilet installation) and/or materials (e.g., toilet)) that the service technician can use to perform the service job, along with a total and/or itemized cost associated with the line item(s).

In embodiments, the machine learning model(s) 114 may receive, as input, a subset of the data 201. The subset of the data 201 can include estimates that occur frequently in the data 201. The high-frequency estimates can include those estimates from the data 201 that have been previously provided to customers (regardless of whether they were converted to a sale) at a frequency that satisfies (e.g., meets or exceeds) a threshold (e.g., five times, six times, etc.).

The data 201, or the subset of the data 201, can be used to train the machine learning model(s) 114. The machine learning model(s) 114 can be trained to generate a plurality of templates 204a-n associated with future jobs to be performed by the tenant. Each template from the plurality of templates 204a-n can correspond to a type of job or a job identification number.

For example, the template 204a from the plurality of templates 204a-n can correspond to a toilet installation job, or a job identification number associated with toilet installation. The template 204b from the plurality of templates can correspond to a water heater installation job, or a job identification number associated with water heater installation, and so on. More than one template can be associated with a particular type of job or job identification number.

Each template from the plurality of templates 204a-n can indicate at least two job estimates. The at least two job estimates can include at least two job estimates indicated by the data 201 (or by the subset of the data 201). For example, the at least two job estimates can include at least two job estimates that have previously been provided by a tenant to one or more customers. The at least two job estimates comprised in a template can include the at least two job estimates that occur most frequently in the data 201 (or by the subset of the data 201) with respect to the corresponding type of job or job identification number. For example, the at least two job estimates comprised in a template associated with toilet installation can include the at least two job estimates that occur most frequently in the data 201 (or by the subset of the data 201) with respect to toilet installation jobs.

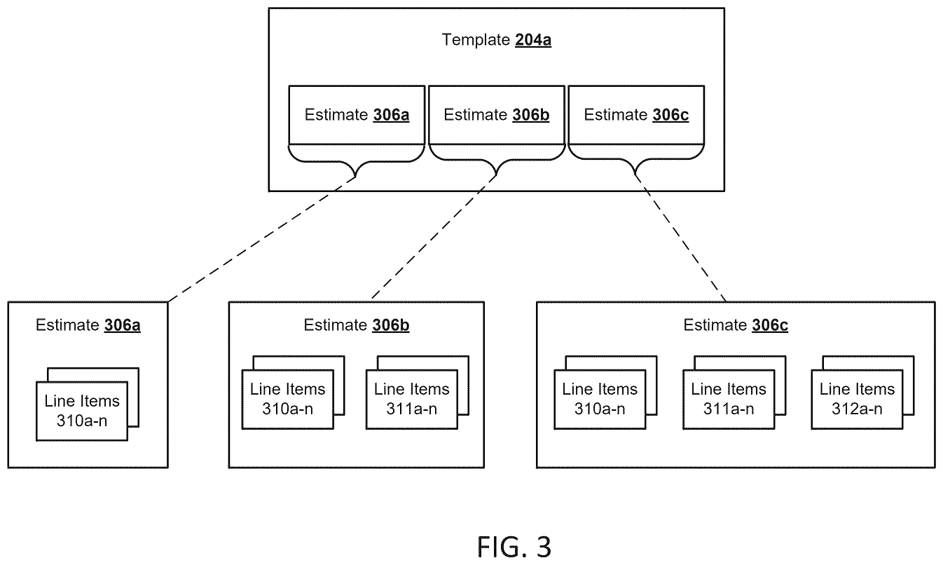

As shown in the example of FIG. 3, each template can include, for example, three estimates (e.g., a “Good-Better-Best” trio). The template 204 can include a first estimate 306a, a second estimate 306b, and a third estimate 306c. The first estimate 306a (e.g., the “Good” estimate) can efficiently resolve the immediate issue associated with the system of the homeowner. The first estimate 306a can be associated with a first price. The first price can be a price associated with at least one first line item 310a-n. The at least one first line item 310a-n can include one or more services or materials for performing a service job.

The second estimate 306b (e.g., the “Better” estimate) can, in addition to addressing the immediate issue, also include preventive maintenance to extend the system lifespan. The second estimate 306b can be associated with a second price. The second price can be higher than the first price. The second price can be a price associated with the at least one first line item 310a-n and at least one second line item 311a-n. The at least one second line item 310a-n can include one or more services or materials for preventive maintenance to extend the system lifespan. The at least one second line item 311a-n can be different than the at least one first line item 310a-n.

The third estimate 306c (e.g., the “Best” estimate) can address the immediate issue, while including preventive maintenance to extend the system lifespan and encompassing comprehensive upgrades that can enhance the entire system. The third estimate 306c can be associated with a third price. The third price can be higher than the second price and/or the first price. The third price can be a price associated with the at least one first line item 310a-n, the least one second line item 311a-n, and at least one third line item 312a-n. The at least one third line item 312a-n can include one or more services or materials for performing comprehensive upgrades that can enhance the entire system. The at least one third line item 312a-n can be different than the at least one second line item 311a-n.

Referring back to FIG. 2, the machine learning model(s) 114 can generate a plurality of templates for the same type of job and/or the same job identification number. For example, the machine learning model(s) 114 can generate a plurality of templates for a toilet installation job, or a job identification number associated with toilet installation. In some embodiments, two or more templates can be consolidated (e.g., merged) into a superset template that differs by only one item. One-item and two-item proposal template results can be merged into a superset template that differs by only one item. For example, a proposal template [x, y] with estimates x and y occurring A times can be merged into another proposal template, such as [x, y, s] or [x, y, d]. In embodiments, the [x, y] template can be merged into the highest occurrence template from this list (e.g., either [x, y, s] or [x, y, d]). Based on the merging, the frequency of the highest accordance template can be augmented accordingly.

FIG. 4 is an example merging process 400. The machine learning model(s) 114 can generate two or more templates for the same type of job and/or the same job identification number. The two or more templates can include the template 204b occurring A times (e.g., 5 times) in the historical data and the template 204c occurring B times (e.g., 6 times) in the historical data. It can be determined (e.g., by the post-processing component 150) that the template 204b indicates a first job estimate 406a, a second job estimate 406b, and a third job estimate 406c. The first job estimate 406a, the second job estimate 406b, and the third job estimate 406c can be associated with a first price, a second price, and a third price, respectively. The second price can be higher than the first price. The third price can be higher than the second price. It can be determined (e.g., by the post-processing component 150) that the template 204c indicates the first job estimate 406a and the second job estimate 406b, but not the third job estimate 406c.

Based on determining that the template 204c indicates the first job estimate 406a and the second job estimate 406b, but not the third job estimate 406c, the template 204c can be merged into the template 206b. Merging the template 204c can be merged into the template 206b can cause generation of a superset template that only differs by one item. For example, merging the template 204c can be merged into the template 206b can cause the frequency of the template 206b to be augmented accordingly. In the example of FIG. 4, the frequency of the template 206b can be augmented such that the first job estimate 406a is associated with a frequency of A+B (e.g., 11), the second job estimate 406b is associated with a frequency of A+B (e.g., 11), and the third job estimate 406c is still associated with a frequency of A (e.g., 5),

Referring back to FIG. 2, the plurality of templates 204a-n generated by the machine learning model(s) 114 can be stored in the storage 118 for later retrieval, such as for use by one or more service technicians associated with the tenant. A first service technician that has been dispatched to perform a service job at a job site can request one or more templates associated with the service job. For example, the first service technician can input, via a user interface 233 of a user device 230a, data associated with the service job to be performed at the job site. The data can indicate a type of job and/or a job identification number associated with the service job to be performed at the job site. The data can be received, such as by the system 100. Based on the data, at least one template from the plurality of templates 204a-n can be determined. The at least one determined template can correspond to the type of job and/or the job identification number associated with the service job to be performed at the job site. The at least one determined template can be retrieved (e.g., from the storage 118). Display of data indicative of the at least one determined template can be caused via the user interface 233 of the user device 230a.

The first service technician can view the displayed template data and/or show the displayed template data to the customer. The customer can view the various estimates comprised in each of the template(s) to select a solution that best aligns with their needs and budget. For example, if the customer just wants the immediate issue addressed (e.g., the customer simply wants the toilet installed), the customer can choose the “Good” estimate. The “If the customer wants the first service technician to address the immediate issue and perform preventive maintenance to extend the lifespan of the system, the customer can choose the “Better” estimate. Finally, if the customer wants the first service technician to address the immediate issue, perform preventive maintenance to extend the lifespan of the system, and encompass one or more comprehensive upgrades to enhance the entire system, the customer can choose the “Best” estimate.

A plurality of different service technicians can access the plurality of templates 204a-n stored in the storage 118. For example, the first service technician can be located at a first premises (e.g., first job site) to perform a service job for a first customer. The first premises can be located remotely from the system 100. As described above, the first service technician can use the user device 230a to retrieve one or more relevant templates from the plurality of templates 204a-n. Likewise, a second service technician can be located at a second, different premises (e.g., second job site) to perform a service job for a second customer. The second premises can be located remotely from the system 100. The second service technician can use the user device 230b to retrieve one or more relevant templates from the plurality of templates 204a-n. A third service technician can be located at a third, different premises (e.g., third job site) to perform a service job for a third customer. The third premises can be located remotely from the system 100. The third service technician can use the user device 230c to retrieve one or more relevant templates from the plurality of templates 204a-n. One or more of the user devices 230a-n can be different types of devices. For example, the user device 230a can be a tablet device, while the device 230b and/or the user device 230c can be a mobile phone.

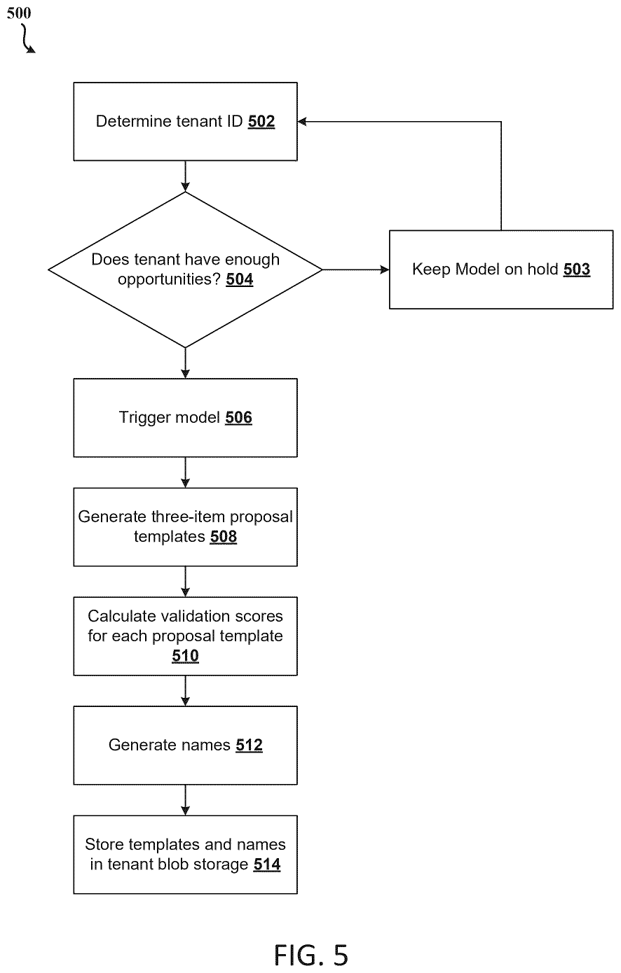

FIG. 5 is an example method 500. The method 500 may comprise a computer implemented method for digital template management. A system and/or computing environment, such as the system 100 of FIG. 1, the system 200 of FIG. 2 and/or the computing environment of FIG. 8, may be configured to perform the method 500.

At 502, a tenant identification number can be determined. The tenant identification number can be a unique code associated with a particular tenant (e.g., service business). At 504, it can be determined if the tenant is associated with enough historical data to train a template generation machine learning model (e.g., machine learning model(s) 114). It can be determined if the tenant is associated with enough historical data to train a template generation machine learning model based on the tenant identification number. For example, the tenant identification number can be used to identify the historical data associated with the tenant. If the tenant is not associated with enough historical data to train a template generation machine learning model, the method 500 can proceed to 503. At 503, training of a template generation machine learning model associated with the tenant can be held (e.g., postponed). Model training for tenants lacking sufficient historical data (e.g., a minimum of 1000 transactions in the last two years) can be held until the quantity of historical data reaches the data threshold.

Conversely, if the tenant is associated with enough historical data to train a template generation machine learning model, the method 500 can proceed to 506. At 506, training of the template generation machine learning model can be triggered. The template generation machine learning model can be trained using the historical data associated with the template.

The template generation machine learning model can be trained to generate a plurality of templates associated with jobs to be performed by the tenant. Each template from the plurality of templates can correspond to a type of job. Each template from the plurality of templates can indicate three estimates. At 508, a plurality of three-estimate proposal templates can be generated by the template generation machine learning model. At 510, validation scores can be determined for each three-estimate proposal template. The validation scores can be determined, for example, using a validation dataset generated based on the historical data. Based on the validation scores satisfying a threshold, the method 500 can proceed to 512.

At 512, a name can be generated for each generated template. A large language model can be used to generate the names for at least a portion of the templates. For example, a prompt can be input into the large language model to cause the large language model to generate the names for at least a portion of the templates. At 514, the templates, along with the corresponding names, can be stored. The templates and the names can be stored in a storage (e.g., blob) associated with the tenant.

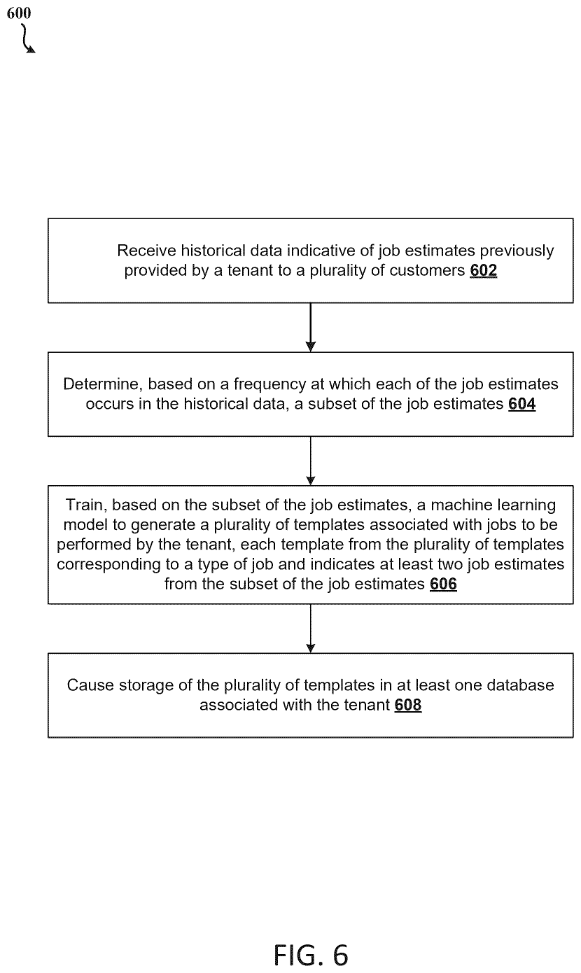

FIG. 6 is an example method 600. The method 600 may comprise a computer implemented method for digital template management. A system and/or computing environment, such as the system 100 of FIG. 1, the system 200 of FIG. 2 and/or the computing environment of FIG. 8, may be configured to perform the method 600.

At 602, historical data can be received. The historical data can be indicative of job estimates. The historical data can be associated with a particular tenant. The job estimates can include job estimates previously provided by the tenant to a plurality of customers. The historical data can include features specific to various service job requests received by the tenant. The features may include, for example, service job revenue, profits, job estimates that the tenant has previously provided to customers (regardless of whether they were converted to a sale), service job totals and/or other features over a period of time.

At 604, a subset of the job estimates can be determined. The subset of the job estimates can be determined based on a frequency at which each of the job estimates occurs in the historical data. The subset of the job estimates can include estimates that occur frequently in the historical data. The subset of the job estimates can include those estimates from the historical data that have been previously provided to customers (regardless of whether they were converted to a sale) at a frequency that satisfies (e.g., meets or exceeds) a threshold (e.g., five times, six times, etc.).

At 606, a machine learning model can be trained. The machine learning model can be trained based on the subset of the job estimates. The machine learning model can be trained to generate a plurality of templates associated with jobs to be performed by the tenant. Each template from the plurality of templates can correspond to a type of job. Each template from the plurality of templates can indicate at least two job estimates from the subset of the job estimates. Training the machine learning model to generate the plurality of templates associated with jobs to be performed by the tenant can include training the machine learning model to determine, for each type of job, the at least two job estimates that occur most frequently in the subset of the historical data.

In embodiments, each of the at least two job estimates can include a first job estimate associated with a first price, a second job estimate associated with a second price, and a third job estimate associated with a third price. The second price can be higher than the first price. The third price can be higher than the second price. The first job estimate can be associated with at least one first line item (e.g., at least one first service or material). The second job estimate can be associated with the at least one first line item and at least one second line item (at least one second service or material). The third job estimate can be associated with the at least one first line item, the at least one second line item, and at least one third line item (e.g., at least one third service or material).

In embodiments, the plurality of templates includes at least a first template associated with a first type of job and a second template associated with the same first type of job. It can be determined that the at least two job estimates indicated by the first template consist of a first job estimate associated with a first price, a second job estimate associated with a second price, and a third job estimate associated with a third price. The second price can be higher than the first price. The third price can be higher than the second price. It can be determined that the at least two job estimates indicated by the second template consist of the first job estimate and the second job estimate (but not the third job estimate). Based on determining that the at least two job estimates indicated by the second template consist of the first job estimate and the second job estimate (but not the third job estimate), the second template can be merged into the first template.

At 608, storage of the plurality of templates in least one database associated with the tenant can be caused. The stored plurality of templates can later be retrieved, such as for use by one or more service technicians associated with the tenant. For example, a service technician that has been dispatched to perform a service job at a job site can request one or more templates associated with the service job. For example, the service technician can input, via a user interface of a user device, data associated with the service job to be performed at the job site. The data can indicate a type of job and/or a job identification number associated with the service job to be performed at the job site. The data can be received. Based on the data, at least one template from the plurality of stored templates can be determined. The at least one determined template can correspond to the type of job and/or the job identification number associated with the service job to be performed at the job site. The at least one determined template can be retrieved (e.g., from the storage). Display of data indicative of the at least one determined template can be caused via the user interface of the user device.

The service technician can view the displayed template data and/or show the displayed template data to the customer. The customer can view the various estimates comprised in each of the template(s) to select a solution that best aligns with their needs and budget. For example, if the customer just wants the immediate issue addressed (e.g., the customer simply wants the toilet installed), the customer can choose the “Good” estimate. The “If the customer wants the service technician to address the immediate issue and perform preventive maintenance to extend the lifespan of the system, the customer can choose the “Better” estimate. Finally, if the customer wants the service technician to address the immediate issue, perform preventive maintenance to extend the lifespan of the system, and encompass one or more comprehensive upgrades to enhance the entire system, the customer can choose the “Best” estimate.

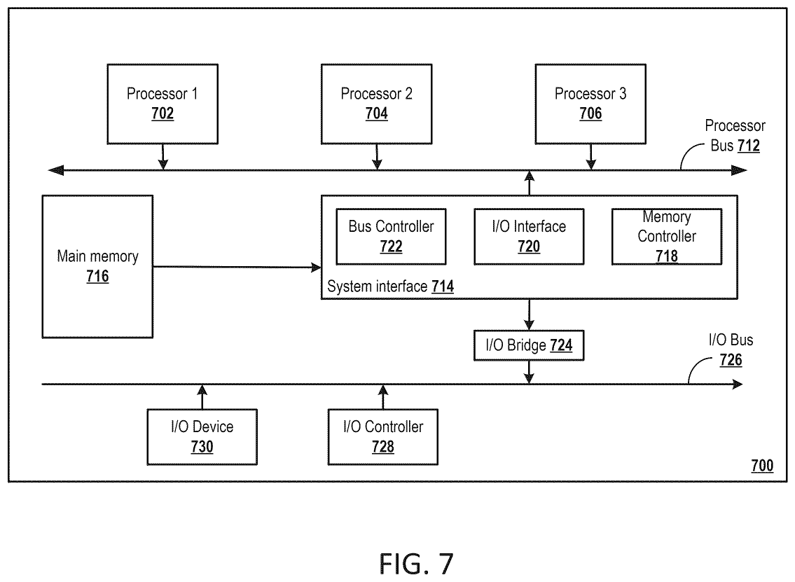

FIG. 7 depicts a computing device that may be used in various aspects, such as the devices and/or components depicted in FIGS. 1-2. With regard to the example architecture of FIGS. 1-2, any of the components may each be implemented in an instance of a computing device 700 of FIG. 7. The computer architecture shown in FIG. 7 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 5-6.

The computer system (system) includes one or more processors (e.g., 702, 704, and 706). The processors 702-706 may include one or more internal levels of cache (not shown) and a bus controller 722 or bus interface unit to direct interaction with a processor bus 712. The processor bus 712, also known as the host bus or the front side bus, may be used to couple the processors 702-706 with a system interface 714. The system interface 714 may be connected to the processor bus 712 to interface other components of the device 700 with the processor bus 712. For example, the system interface 714 may include a memory controller 718 for interfacing a main memory 716 with the processor bus 712. The main memory 716 typically includes one or more memory cards and a control circuit (not shown). System interface 714 may also include an input/output (I/O) interface 720 to interface one or more I/O bridges (e.g., I/O bridge 724) or I/O devices with the processor bus 712. One or more I/O controllers and/or I/O devices may be connected with the I/O bus 726, such as I/O controller 728 and I/O device 730, as illustrated.

I/O device 730 may also include an input device (not shown), such as an alphanumeric input device, including alphanumeric and other keys for communicating information and/or command selections to the processors 702-706. Another type of user input device includes cursor control, such as a mouse, a trackball, or cursor direction keys for communicating direction information and command selections to the processors 702-706 and for controlling cursor movement on the display device.

Device 700 may include a dynamic storage device, referred to as main memory 716, or a random access memory (RAM) or other computer-readable devices coupled to the processor bus 712 for storing information and instructions to be executed by the processors 702-706. Main memory 716 also may be used for storing temporary variables or other intermediate information during execution of instructions by the processors 702-706. Device 700 may include a read only memory (ROM) and/or other static storage device coupled to the processor bus 712 for storing static information and instructions for the processors 702-706. The system set forth in FIG. 7 is but one possible example of a computer system that may employ or be configured in accordance with aspects of the present disclosure.

According to one embodiment, the above techniques may be performed by the device 700 in response to processor 704 executing one or more sequences of one or more instructions contained in main memory 716. These instructions may be read into main memory 716 from another machine-readable medium, such as a storage device. Execution of the sequences of instructions contained in main memory 716 may cause processors 702-706 to perform the process steps described herein. In alternative embodiments, circuitry may be used in place of or in combination with the software instructions. Thus, embodiments of the present disclosure may include both hardware and software components.

A machine-readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 716. Common forms of machine-readable medium may include, but is not limited to, magnetic storage medium; optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc.

Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the subject technology may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving historical data indicative of job estimates previously provided by a tenant to a plurality of customers;
determining, based on a frequency at which each of the job estimates occurs in the historical data, a subset of the job estimates;
training, based on the subset of the job estimates, a machine learning model to generate a plurality of templates associated with jobs to be performed by the tenant, wherein each template from the plurality of templates corresponds to a type of job and indicates at least two job estimates from the subset of the job estimates; and
causing storage of the plurality of templates in at least one database associated with the tenant.

2. The method of claim 1, wherein training the machine learning model to generate the plurality of templates associated with jobs to be performed by the tenant comprises training the machine learning model to determine, for each type of job, the at least two job estimates that occur most frequently in the historical data.

3. The method of claim 1, wherein each of the at least two job estimates comprise a first job estimate associated with a first price, a second job estimate associated with a second price, and a third job estimate associated with a third price, wherein the second price is higher than the first price and the third price is higher than the second price.

4. The method of claim 3, wherein the first job estimate is associated with at least one first line item, the second job estimate is associated with the at least one first line item and at least one second line item, and the third job estimate is associated with the at least one first line item, the at least one second line item, and at least one third line item.

5. The method of claim 1, further comprising:
periodically retraining the machine learning model based on receiving updates to the historical data.

6. The method of claim 1, wherein the plurality of templates comprises at least a first template associated with a first type of job and a second template associated with the same first type of job.

7. The method of claim 6, further comprising:
determining that the at least two job estimates indicated by the first template consist of a first job estimate associated with a first price, a second job estimate associated with a second price, and a third job estimate associated with a third price, wherein the second price is higher than the first price and the third price is higher than the second price; and
based on determining that the at least two job estimates indicated by the second template consist of the first job estimate and the second job estimate, merging the second template into the first template.

8. The method of claim 1, further comprising:
receiving, from a user device located at a premises, input data associated with a type of job to be performed at the premises by the tenant;
determining, based on the input data, at least one template from the plurality of stored templates that corresponds to the type of job to be performed at the premises by the tenant; and
causing display of data indicative of the at least one template via an interface of the user device.

9. The method of claim 1, further comprising:
generating, using at least one large language model (LLM), a title corresponding to each template from the plurality of templates; and
causing storage of the corresponding titles in the at least one database associated with the tenant.

10. The method of claim 9, wherein generating the title corresponding to each template from the plurality of templates comprises:
inputting the prompt into the LLM to cause the LLM to generate the title corresponding to each template from the plurality of templates.

11. The method of claim 1, wherein the machine learning model comprises a Frequent Pattern Growth (FP-Growth) model.

12. A system, comprising:
one or more processors; and
a non-transitory computer-readable storage medium containing instructions which, when executed on the one or more processors, cause the one or more processors to perform operations including:
receiving historical data indicative of job estimates previously provided by a tenant to a plurality of customers;
determining, based on a frequency at which each of the job estimates occurs in the historical data, a subset of the job estimates;
training, based on the subset of the job estimates, a machine learning model to generate a plurality of templates associated with jobs to be performed by the tenant, wherein each template from the plurality of templates corresponds to a type of job and indicates at least two job estimates from the subset of the job estimates; and
causing storage of the plurality of templates in at least one database associated with the tenant.

13. The system of claim 12, wherein training the machine learning model to generate the plurality of templates associated with jobs to be performed by the tenant comprises training the machine learning model to determine, for each type of job, the at least two job estimates that occur most frequently in the historical data.

14. The system of claim 12, wherein each of the at least two job estimates comprise a first job estimate associated with a first price, a second job estimate associated with a second price, and a third job estimate associated with a third price, wherein the second price is higher than the first price and the third price is higher than the second price.

15. The system of claim 14, wherein the first job estimate is associated with at least one first line item, the second job estimate is associated with the at least one first line item and at least one second line item, and the third job estimate is associated with the at least one first line item, the at least one second line item, and at least one third line item.

16. The system of claim 12, wherein the plurality of templates comprises at least a first template associated with a first type of job and a second template associated with the same first type of job, the operations further comprising:
determining that the at least two job estimates indicated by the first template consist of a first job estimate associated with a first price, a second job estimate associated with a second price, and a third job estimate associated with a third price, wherein the second price is higher than the first price and the third price is higher than the second price; and
based on determining that the at least two job estimates indicated by the second template consist of the first job estimate and the second job estimate, merging the second template into the first template.

17. A computer-readable medium storing instructions that, when executed, cause:
receiving historical data indicative of job estimates previously provided by a tenant to a plurality of customers;
determining, based on a frequency at which each of the job estimates occurs in the historical data, a subset of the job estimates;
training, based on the subset of the job estimates, a machine learning model to generate a plurality of templates associated with jobs to be performed by the tenant, wherein each template from the plurality of templates corresponds to a type of job and indicates at least two job estimates from the subset of the job estimates; and
causing storage of the plurality of templates in at least one database associated with the tenant.

18. The computer-readable medium of claim 17, wherein training the machine learning model to generate the plurality of templates associated with jobs to be performed by the tenant comprises training the machine learning model to determine, for each type of job, the at least two job estimates that occur most frequently in the historical data.

19. The computer-readable medium of claim 17, wherein each of the at least two job estimates comprise a first job estimate associated with a first price, a second job estimate associated with a second price, and a third job estimate associated with a third price, wherein the second price is higher than the first price and the third price is higher than the second price.

20. The computer-readable medium of claim 19, wherein the first job estimate is associated with at least one first line item, the second job estimate is associated with the at least one first line item and at least one second line item, and the third job estimate is associated with the at least one first line item, the at least one second line item, and at least one third line item.
